(19) United States
(12) Patent Application Publication
(10) Pub. No.: US 2023/0029061 A1
(43) Pub. Date: Jan. 26, 2023

(54) Hybrid Coating System

(71) Applicant: Lubrizol Advanced Materials, Inc., Cleveland, OH (US)

(72) Inventors: Nathan J. Bartlett, Matlock, Derbyshire (GB); Vic Stanislawczyk, Strongsville, OH (US); Dean Thetford, Rochdale (GB)

(73) Assignee: Lubrizol Advanced Materials, Inc., Cleveland, OH (US)

(21) Appl. No.: 17/783,414

(22) PCT Filed: Dec. 14, 2020
(86) PCT No.: PCT/US2020/064843

§ 371 Date: Jun. 8, 2022

Related U.S. Application Data
(60) Provisional application No. 62/951,006, filed on Dec. 20, 2019.

(51) Int. Cl. C04B 28/00; C04B 24/26; C04B 14/30; C04B 22/06

(52) U.S. Cl. CPC C04B 28/00; C04B 24/2641; C04B 14/306; C04B 22/062; C04B 2103/0093

(57) ABSTRACT

A two-component hybrid coating system which contains both an organic film forming polyacrylate polymer and particles capable of forming a geopolymer is provided. When the two reactive components are combined, a hybrid coating composition is provided containing a film forming organic polyacrylate polymer component and a geopolymer component.

### BACKGROUND OF THE INVENTION

Coating composition containing inorganic film forming components, such as geopolymers are known in the art. Geopolymers have a network-like structure of amorphous inorganic polymer and are understood to have good adhesive properties. Due to their high degree of compactness, excellent interface coalescence, impermeability, and freeze-thaw resistance properties, geopolymers are understood to be good candidates for combination with other film forming materials to provide coating compositions

Some current geopolymer containing coatings form geopolymers by the sequential addition and mixing of individual ingredients in order to form an active coating composition which must be used immediately. For other coatings, a dry mix of materials capable of forming a geopolymer is prepared to which water can be added to form an active coating composition. However, the addition of water to the hygroscopic alkali powders causes exothermic release of solution energy which reduces the workability/application window of the coating composition, creates additional hazards for the operator/user, and creates challenges in dispersing other polymer particles in the coating composition as well as in solvating the geopolymer activator effectively during mixing.

Therefore, it is desirable to have a coating composition which provides the benefits of a geopolymer coating composition and an organic latex coating composition. In particular, it is desirable for coating compositions to have improved scratch resistance.

### SUMMARY OF THE INVENTION

The present invention provides a hybrid organic/inorganic coating system. In one embodiment, the coating system of the present invention comprises a reactive coating system having two separate components. A first component is an activating liquid which comprises (1) a polymer emulsion comprising polyacrylate latex polymer solids or the powdered polymer derived therefrom, (2) an alkali silicate, and (3) solvent. The second component is a reactive solid comprising an aluminosilicate. The reactive solid may also comprise an amphoteric metal oxide. In one embodiment, the alkali silicate in the activating liquid component may be selected from various commercially available or premade alkali silicates. In one embodiment, the alkali silicate comprises the reaction product of (a) an alkali metal oxide, an alkali metal hydroxide, an alkali metal carbonate, an alkali metal bicarbonate, or mixtures thereof with (b) colloidal silica.

In one embodiment, the reactive coating system of the present invention comprises 20% to 90%, or 60% to 85%, or 70% to 80% by weight of the activating liquid component and 10% to 80%, or 15% to 40%, or 20 to 30% by weight of the reactive solid mixture. In such an embodiment, the activating liquid component comprises 0.5% to 35%, or 2% to 30%, or 5% to 25% by weight latex polymer solids of the polyacrylate emulsion polymer or powdered polymer derived therefrom 5% to 49%, or 18% to 45%, or 30 to 40% by weight alkali silicate, 16% to 94.5%, or 25% to 80%, or 35% to 65% by weight solvent, and optionally further comprises one or more other additives in amounts of 0% to 15%, or 0.5% to 10% by weight. Also, in such an embodiment, the reactive solid mixture comprises 70% to 99.5% or 80% to 99%, or 85% to 99% by weight aluminosilicate and 0.5% to 30%, or 1% to 20%, or 1% to 15% amphoteric metal oxide.

Another embodiment of the invention provides a coating composition comprising a geopolymer component, wherein the geopolymer component comprises the reaction product of an alkali metal silicate and an aluminosilicate, a polyacrylate polymer emulsion, and an amphoteric metal oxide. The coating composition contains molar ratios of Si/Al of 0.5 to 3.0, or 1.5 to 2.5, or even 1.75 to 2.25. The coating composition may also have an M/Al ratio of 0.5 to 2.5, or even 1.0 to 2.0.

In the present invention, the amphoteric metal oxide comprises a metal oxide containing a group 3, 4 or 12 transition metal species or a group 13 element. For example, the amphoteric metal oxide may comprise boron oxide, aluminum oxide, zirconium oxide, scandium oxide, yttrium oxide, zinc oxide, cerium oxide, or mixtures thereof. In one embodiment, the amphoteric metal oxide comprises or consists of zirconium oxide which may optionally be yttria stabilized.

The various embodiments will be described in more detail below in the following detailed description of the invention.

### DETAILED DESCRIPTION OF THE INVENTION

Various preferred features and embodiments will be described below by way of non-limiting illustration.

The amount of each chemical component described is presented exclusive of any solvent, which may be customarily present in the commercial material, that is, on an active chemical basis, unless otherwise indicated. However, unless otherwise indicated, each chemical or composition referred to herein should be interpreted as being a commercial grade material which may contain the isomers, by-products, derivatives, and other such materials which are normally understood to be present in the commercial grade.

The use of (meth) in a chemical name in this document is meant to indicate that a methyl substituent is optionally present. Thus, the term “(meth)acrylate monomer” includes acrylate, methacrylate, diacrylate, and dimethacrylate monomers.

It is known that some of the materials described above may interact in the final formulation, so that the components of the final formulation may be different from those that are initially added. For instance, the alkali silicate component in the activating liquid component reacts with the aluminosilicate in the reactive solid to form the geopolymer component in the final coating composition. The products formed thereby, including the products formed upon employing the composition of the present invention in its intended use, may not be susceptible of easy description. Nevertheless, all such modifications and reaction products are included within the scope of the present invention; the present invention encompasses the composition prepared by admixing the components described above.

### Activating Liquid Component

The activating liquid component of the present invention contains a polyacrylate polymer emulsion, an alkali silicate, and a solvent. In some embodiments of the present invention, the three components are combined in a manner provide a metastable colloidal solution that does not crystalize and thus, the activating liquid component is shelf-stable. In one embodiment, the activating liquid component of the present invention is capable of having high concentrations of alkali silicate contained therein.

Polyacrylate polymer emulsions useful in the present invention may be selected from those now known or hereafter developed. As used herein, the term “polyacrylate polymer emulsion” means a dispersion of microparticles of acrylate polymers in a liquid substance. Typically, the liquid substance is water. In some embodiments of the present invention, the acrylate polymers in the polyacrylate polymer emulsion that are dried into powders that are later dispersed or are dispersible in water. Latex solids powders useful in the present invention are homopolymers or copolymers prepared from and containing residues of monomers such acrylate, methacrylate, acrylic acid, methacrylic acid, alkyl (meth)acrylate, acrylate esters (e.g. ethyl, n-butyl etc.), vinyl chloride, vinylidene chloride, vinyl acetate, vinyl trimethoxysilane, styrene, acrylamide, diacetone acrylamide, and dienes such as butadiene or combinations thereof. In one embodiment, the polyacrylate polymer used in the present invention contains latex polymer solids or the powdered polymer derived therefrom. In another embodiment, the dried polyacrylate polymer powder can be mixed directly into the reactive coating system.

The polyacrylate polymer emulsions used in the present invention are characterized by glass transition temperatures of less than 150° C., or even less than 100° C., or even less than 75° C., or even less than 40° C., or even less than 30° C. Independently, the glass transition temperature is at least −40° C., or even at least −20° C., or even at least −10° C., or even at least −5° C. The polyacrylate polymer emulsion may include various additives such as surfactants, defoamers, latex stabilizers, and combinations thereof as are known in the art. Polyacrylate polymer emulsions useful in the present invention may have a polymer solids content of around 30% to 60% by weight or even 40% to 50% by weight. Commercially available polyacrylate polymer emulsions include Carboset® and Hycar® polymer emulsions available from Lubrizol Advanced Materials, Inc.

The activating liquid component also contains an alkali silicate. Useful alkali silicates are represented by the formula M₂ₙSiO₂₊ₙ, but may also be described as (M₂O)ₙSiO₂ or (M₂O)ₙSiO₂.xH₂O or M₂ₙSiO₂₊ₙxH₂O. In these formulas, M represents an alkali metal, for example, sodium, lithium, or potassium, or mixtures thereof. In some embodiments, the alkali silicate is free of or substantially free of calcium or magnesium, as such alkali silicates will not provide desirable geopolymers in the coating compositions of the present invention. In the formulas above, n may be from 0.33 to 1.33, for example, 0.63 to 1.25. In some embodiments, the alkali metal silicate will have a molar (or weight (wt.)) ratio of SiO₂/M₂O (where M=Li, Na, K or mixtures thereof) of 3.0 to 0.75, or even 1.6 to 0.8.

Alkali silicate useful in the present invention may be selected from a variety of sodium, lithium, and/or potassium silicates or mixtures thereof. In one embodiment, the alkali silicate comprises or consists of sodium metasilicate. Examples of commercially available alkali silicates are available from various suppliers including PQ Corporation (US), Groupo IQE (Spain), ICL (UK), and Ankit (India). Alkali silicates useful for this invention are available commercially and are understood to varying compositions by those skilled in the art. Many of these have non-integer stoichiometry. Their behavior is complex but is documented in the literature (e.g. Weldes and Lange. “Properties of Soluble Silicates,” Industrial and Engineering Chemistry, Vol. 61, No. 4, April 1969).

In another embodiment, the alkali silicate comprises the reaction product of colloidal silica with an alkali metal oxide, an alkali metal hydroxide, an alkali metal carbonate, an alkali metal bicarbonate, or mixtures thereof. Colloidal silica is a suspension of fine amorphous, nonporous, and typically spherical silica particles in a liquid phase. Commercially available colloidal silicas contain about 10% to about 60% by weight SiO₂. In some embodiments, the SiO₂ particles are around 1 to 100 nm in size. In some embodiments, the colloidal silicas are negatively charged solutions stabilized by the addition of for example, Na₂O, NaOH, NH₄OH, at low treat rates such as from 0.025% to 1.5% of the total weight of the colloidal silica formulation. In other embodiments, the colloidal silicas are positively charged solutions stabilized by surface coatings of Al₂O₃, Al₂O₃ and Cl at treat rates of 0.025% to 2.5% of the total weight of the colloidal silica formulation. Examples of commercially available colloidal silicas include those sold under the following trademarks: LUDOX® (E.I. duPont de Nemours & Co., Wilmington, Del.), NALCOAG® (Nalco Chemical Co., Chicago, Ill.), NYACOL® (Nyacol, Inc., Ashland, Mass.), SNOWTEX® (Nissan Chemical Industries, Ltd., Tokyo, Japan), and SYTON® (Monsanto Ltd., London, England and St. Louis, Mo.). Alkali metal oxides, hydroxides, carbonates, bicarbonates, are well known in the art and include those based on sodium, lithium, or potassium.

In one embodiment, the alkali silicate may be formed in situ in the activating liquid component, by combining in the activating liquid component colloidal silica with an alkali metal oxide, an alkali metal hydroxide, an alkali metal carbonate, an alkali metal bicarbonate, or mixtures thereof. In some embodiments, preparing the alkali silicate in situ allows the activating liquid component to have a higher concentration of alkali silicate than when a pre-made alkali silicate is used.

The activating liquid component also comprises one or more solvents. In one embodiment, the solvent comprises or consists of water. In another embodiment, the solvent comprises water and one or more co-solvents miscible with water. Such co-solvents may include, for example, alcohols such as C1-6 aliphatic alcohols such as ethanol, isopropanol, diacetone alcohol, glycols such as C2-6 alkylene glycols, alcohol ethers such as methoxy-, ethoxy-, propoxy- and butoxyethanol, methoxy-, ethoxy-, propoxy- and butoxypropanol, glycol ethers such as diethylene glycol and dipropylene glycol, glycol esters such as 2-ethoxyethyl acetate, 2-ethoxypropyl acetate, or polyglycols such as polyethyleneglycol, where the polyethylene glycol has a MW of less than 600.

The activating liquid component will contain about 0.5% to 35%, or 2% to 30%, or 5% to 25% by weight latex polymer solids or the powdered polymer derived therefrom of the polyacrylate emulsion polymer, about 5% to 49%, or 18% to 45%, or 30 to 40% by weight alkali silicate, about 16% to 94.5%, or 25% to 80%, or 35% to 65% by weight solvent. The activating liquid component may optionally contain other additives. If included the other additives may be included in amounts up to about 15% by weight (e.g. 0% to about 15% by weight, or 0.5% to about 10% by weight).

### Reactive Solid Mixture

The reactive solid mixture component of the present invention contains an aluminosilicate material and an amphoteric metal oxide. When combined with the activating liquid component the aluminosilicate material reacts with the alkali silicate in a geopolymerization reaction over the course of several hours or even days to provide a finished hard coating that exhibits properties superior over coatings made from polyacrylate polymer emulsions or geopolymers alone.

The aluminosilicate useful in the present invention may be derived from calcined clay, incineration ash, including but not limited to fly ash, rice husk ash, sugarcane leaves ash, palm oil ash, boiler ash, wastepaper sludge ash, municipal solid waste ash, bottom ash, natural pozzolans, volcanic ash, ground granulated blast furnace slag (from steel or iron), industrial ground slag, including but not limited to phosphorous, ferronickel, ferrochrome magnesia-iron, copper, nickel, titaniferous, mine tailings or wastes (including but not limited to coal gangue, red mud) zeolite, feldspars, and mixtures thereof. In one embodiment, the aluminosilicate comprises or consists of metakaolin.

The amphoteric metal oxides useful in the present invention may be selected from metal oxides containing a group 3 or group 4 or group 12 transition metal species or a group 13 element. For example, the amphoteric metal oxide may be selected from boron oxide, aluminum oxide, zirconium oxide, scandium oxide, yttrium oxide, zinc oxide, hafnium oxide, or mixtures thereof. In one exemplary embodiment the amphoteric metal oxide comprises or consists of zirconium oxide. In another exemplary embodiment, the amphoteric metal oxide comprises or consists of yttria stabilized zirconium oxide, for example, yttria stabilized zirconium oxide. In yttria-stabilized zirconia, the cubic crystal structure of zirconium oxide is made stable at room temperature by the addition of yttrium oxide.

In the present invention, the reactive solid mixture comprises 70% to 99.5% or 80% to 99%, or 85% to 99% by weight aluminosilicate and 0.5% to 30%, or 1% to 20%, or 1% to 15% amphoteric metal oxide.

It is also contemplated that in some embodiments, coating compositions in accordance with the present invention may be formulated such that the amphoteric metal oxides may be dispersed in the activating liquid portion of the coating composition and lead to the same advantages as described herein.

In some embodiments, the coating composition of the present invention may include one or more additional additives. These additional additives are typically included as part of the reactive liquid composition, but it is also contemplated that these additional additives could be part of the reactive solid mixture or added after the two components are combined to form the coating composition. Examples of these additional additives are described below.

In some embodiments, the coating composition may further contain one or more additional polymers. The polymers may be included as solids or in the form of a solution or dispersion. These additional polymers can perform a variety of functions in the coating composition or in the final coating. However, the additional polymers are not a required component for the essential features of the disclosure.

The aqueous coating compositions can further include one or more additives, including pigments, fillers, dispersants, coalescents, pH modifying agents, plasticizers, defoamers, surfactants, rheology modifiers or thickeners, humectants, flame retardants, surfactants, preservatives, biocides, corrosion inhibitors, co-solvents, and combinations thereof. The choice of additives in the composition will be influenced by a number of factors, including but not limited to the intended use of the coating composition.

Examples of suitable pigments include metal oxides, such as titanium dioxide, zinc oxide, iron oxide, or combinations thereof. In certain embodiments, the composition includes a titanium dioxide pigment. Examples of commercially titanium dioxide pigments are KRONOS® 2101, KRONOS® 2310, available from Kronos WorldWide, Inc. (Cranbury, N.J.), TI-PURE® R-900, available from DuPont (Wilmington, Del.), or TIONA® AT1 commercially available from Millenium Inorganic Chemicals. Titanium dioxide is also available in concentrated dispersion form. An example of a titanium dioxide dispersion is KRONOS® 4311, also available from Kronos WorldWide, Inc.

Examples of suitable fillers include calcium carbonate, nepheline syenite, (25% nepheline, 55% sodium feldspar, and 20% potassium feldspar), feldspar (an aluminosilicate), diatomaceous earth, calcined diatomaceous earth, talc (hydrated magnesium silicate), silica (silicon dioxide), alumina (aluminum oxide), clay, (hydrated aluminum silicate), kaolin (kaolinite, hydrated aluminum silicate), mica (hydrous aluminum potassium silicate), pyrophyllite (aluminum silicate hydroxide), perlite, baryte (barium sulfate), Wollastonite (calcium metasilicate), and combinations thereof. In certain embodiments, the composition comprises a calcium carbonate filler. In some embodiments, the fillers will be included in the reactive solid mixture portion of the coating composition. If included, the fillers may be present in amounts of up to 50% by weight of the reactive solid mixture. In cases where fillers are included, the amount of the aluminosilicate in the reactive solid mixture will be reduced to accommodate for the presence of the fillers.

Examples of suitable dispersants are polyacid dispersants and hydrophobic copolymer dispersants. Polyacid dispersants are typically polycarboxylic acids, such as polyacrylic acid or polymethacrylic acid, which are partially or completely in the form of their ammonium, alkali metal, alkaline earth metal, ammonium, or lower alkyl quaternary ammonium salts. Other useful dispersants include fully or partially polyethoxylated, or polypropoxylated, polyacid acid esters, also known as polycarboxylate ethers, which are partially or completely in the form of their ammonium, alkali metal, alkaline earth metal, ammonium, or lower alkyl quaternary ammonium salts. Hydrophobic copolymer dispersants include copolymers of acrylic acid, methacrylic acid, or maleic acid with hydrophobic monomers. In certain embodiments, the composition includes a polyacrylic acid-type dispersing agent, such as Pigment Disperser N, commercially available from BASF SE.

Suitable coalescents, which aid in film formation during drying, include ethylene glycol monomethyl ether, ethylene glycol monobutyl ether, ethylene glycol monoethyl ether acetate, ethylene glycol monobutyl ether acetate, diethylene glycol monobutyl ether, diethylene glycol monoethyl ether acetate, dipropylene glycol monomethyl ether, 2,2,4-trimethyl-1,3-pentanediol monoisobutyrate, and combinations thereof.

Examples of suitable rheology modifiers or thickening agents include hydrophobically modified ethylene oxide urethane (HEUR) polymers, hydrophobically modified alkali soluble emulsion (HASE) polymers, hydrophobically modified hydroxyethyl celluloses (HMHECs), hydrophobically modified polyacrylamide, and combinations thereof. HEUR polymers are linear reaction products of diisocyanates with polyethylene oxide end-capped with hydrophobic hydrocarbon groups. HASE polymers are homopolymers of (meth)acrylic acid, or copolymers of (meth)acrylic acid, (meth)acrylate esters, or maleic acid modified with hydrophobic vinyl monomers. HMHECs include hydroxyethyl cellulose modified with hydrophobic alkyl chains. Hydrophobically modified polyacrylamides include copolymers of acrylamide with acrylamide modified with hydrophobic alkyl chains (N-alkyl acrylamide). In certain embodiments, the coating composition includes a hydrophobically modified hydroxyethyl cellulose thickener.

Defoamers serve to minimize frothing during mixing and/or application of the coating composition. Suitable defoamers include silicone oil defoamers, such as polysiloxanes, polydimethylsiloxanes, polyether modified polysiloxanes, and combinations thereof. Exemplary silicone-based defoamers include BYK®-035, available from BYK USA Inc. (Wallingford, Conn.), the TEGO® series of defoamers, available from Evonik Industries (Hopewell, Va.), and the DREWPLUS® series of defoamers, available from Ashland Inc. (Covington, Ky.). Other suitable defoamers include non-silicone defoamers or silicone free defoamers, such as oil based, or oil emulsions. Exemplary non-silicone defoamers include Efka™ 2526, Efka™ 2788 available from BASF SE, BYK™ 011 available from BYK USA Inc. (Wallingford, Conn.).

Suitable biocides can be incorporated to inhibit the growth of bacteria and other microbes in the coating composition during storage. Exemplary biocides include 2-[(hydroxymethyl)amino]ethanol, 2-[(hydroxymethyl) amino]2-methyl-1-propanol, o-phenylphenol, sodium salt, 1,2-benzisothiazolin-3-one, 2-methyl-4-isothiazolin-3-one (MIT), 5-chloro2-methyland-4-isothiazolin-3-one (CIT), 2-octyl-4-isothiazolin-3-one (OTT), 4,5-dichloro-2-n-octyl-3-isothiazolone, as well as acceptable salts and combinations thereof. Suitable biocides also include mildewcides that inhibit the growth mildew or its spores in the coating. Examples of mildewcides include 2-(thiocyanomethylthio)benzothiazole, 3-iodo-2-propynyl butyl carbamate, 2,4,5,6-tetrachloroisophthalonitrile, 2-(4-thiazolyl)benzimidazole, 2-N-octyl4-isothiazolin-3-one, diiodomethyl p-tolyl sulfone, as well as acceptable salts and combinations thereof. In certain embodiments, the coating composition contains 1,2-benzisothiazolin-3-one or a salt thereof. Biocides of this type include PROXEL® BD20, commercially available from Arch Chemicals, Inc (Atlanta, Ga.).

Exemplary co-solvents and plasticizers include ethylene glycol, propylene glycol, diethylene glycol, and combinations thereof.

When the two components of the coating system described herein are combined, they form a coating composition comprising a geopolymer component formed from the reaction product of the alkali metal silicate contained in the activating liquid component and the aluminosilicate contained in the reactive solid component. The coating composition also contains the polyacrylate polymer and the amphoteric metal oxide. The fully formulated combined coating composition typically comprises molar ratio ranges of Si/Al of 0.5 to 3.0, or 1.5 to 2.5, or 1.75 to 2.25. The coating composition may also comprise a ratio of M/Al of 0.5 to 2.5, or 1.0 to 2.0.

Coating compositions can be applied to a surface by any suitable coating technique, including spraying, rolling, brushing, or spreading. Coating compositions can be applied in a single coat, or in multiple sequential coats (e.g., in two coats or in three coats) as required. Generally, the coating composition is allowed to dry under ambient conditions. However, in certain embodiments, the coating composition can be dried, for example, by heating and/or by circulating air over the coating.

Coating thickness can vary depending upon the application of the coating. For example, the coating can have a dry thickness of at least one or 10 mils (e.g., at least 15 mils, at least 20 mils, at least 25 mils, at least 30 mils, or at least 40 mils) for elastomeric coatings, especially where the coating needs to bridge cracks in the substrate. In such elastomeric instances, the coating has a dry thickness of less than 100 mils (e.g., less than 90 mils, less than 80 mils, less than 75 mils, less than 60 mils, less than 50 mils, less than 40 mils, less than 35 mils, or less than 30 mils). In some elastomeric embodiments, the coating has a dry thickness of between 10 mils and 100 mils. In certain embodiments, the coating has a dry thickness of between 10 mils and 40 mils. For less elastomeric coatings, such as metal coatings, and where the Tg can be from 15 or 25 to 80° C., the coating thickness may tend to be thinner such as one to 10 or one to five mils dry thickness.

The coating compositions can be applied to a variety of surfaces including, but not limited to metal, asphalt, concrete, stone, ceramic, wood, plastic, polymer, polyurethane foam, glass, and combinations thereof. The coating compositions can be applied to interior or exterior surfaces. In certain embodiments, the surface is an architectural surface, such as a roof, wall, floor, or combination thereof.

### Examples

The following examples provide illustrations of the invention. These examples are non-exhaustive and are not intended to limit the scope of the invention.

In the Examples below, the full coating composition but specifically the activating liquid components were prepared by two different methods. The two methods for the whole coating composition are hence identified as preparation method A and preparation method B.

Preparation Method A: Stage I: Formulations were prepared in 250 mL wide neck glass jars with a modified screw lid which enables addition and stirring, with an overhead stirrer (saw tooth stirrer) used through ports in the lid, without lid removal. To this jar under a flow of nitrogen gas was added water. Stirring was started 100-500 rpm and the polymer emulsion was added slowly (typically over 5 mins). After this addition the solid sodium metasilicate was added. The stirring speed during addition period was 1000-1500 rpm occasionally lowering to 300 rpm while the lid addition port was open to avoid splashing out of the container. During the addition of alkali silicate an exotherm was observed. Stirring at this stage was continued for 1 hr. The product of this preparation gave the activating liquid of Preparation Method A. Stage II: Separately, metakaolin was combined with 8% yttria stabilized zirconium oxide in a suitable glass jar, this jar was then sealed, and the dry powders mixed on a lab roller mixer until homogeneous. The product of this preparation gave the reactive solid of Preparation Method A. Stage III: The full coating composition of Preparation Method A was prepared by adding the prepared reactive solid to the prepared activating liquid in a 250 mL, wide neck glass jar with a modified screw lid which enables addition and stirring, with an overhead stirrer (saw tooth stirrer) through ports in the lid, without lid removal. The reactive solid was added in small portions over 5 mins, allowing the solid to wet during mixing with stirrer speeds between 300-1000 rpm. After full addition of the reactive solid to the activating liquid, the full coating composition was mixed no longer than an additional 10 mins before applying a wet coating film. The full coating composition was then applied to precleaned stainless steel Q panels, with an applicator bar. Before drying in a controlled temperature oven at 30° C. A minimum cure time of 7 days was allowed before testing and analysis of the panels. The panel samples of examples included were prepared on the same day and later after curing tested on same day, all sample plates were cured under identical conditions before testing.

Preparation Method B: Stage I: To an appropriate jar/container (or reaction vessel) was added 50% aqueous sodium hydroxide solution. A blanket of nitrogen was applied to avoid carbonation of the alkali solution. This was gently stirred until maximum dissolution had occurred. This was then diluted with the additional water added dropwise with stirring (EXOTHERMIC—temperature of the mixture was cooled such that the process temperature did not exceed 60° C.). After this addition and 10-15 mins for complete mixing, colloidal silica, LUDOX™—50 was added dropwise. On completion of the addition, the mixture was stirred until the solution was homogeneous and all solid had dissolved. Stage II: A portion of the prepared alkali silicate solution was placed in a suitable container ready for mixing in the emulsion polymer. The mixture was cooled to 15-20° C. A high sheer mixing regime was then used where the polymer premix portion was added directly into the high sheer mixing area of the container. High stirrer speeds of greater than 1000 rpm were used. The polymer premix was added dropwise (slowly) into the alkali silicate solution with high sheer mixing over 10-15 mins. Mixing was then continued for a further 30 minutes to further break up agglomerates. After completion a small sample (10 g) was removed and placed into a small 28 mL glass vial for stability studies, the remainder was then used in Stage IV. The product of this stage of the preparation was the activating liquid of Preparation Method B and could be stored before using in the full coating composition. Stage III: Separately, metakaolin was combined with 8% yttria stabilized zirconium oxide in a suitable glass jar, this jar was then sealed, and the dry powders mixed on a lab roller mixer until homogeneous. The product of this preparation provides the reactive solid of Preparation Method B and could be stored before using in the full coating composition. Stage IV: To the desired quantity of activating liquid was then added the reactive solid, using hand mixing with a spatula to wet the solid and then using gentle/slow stirring for 5-10 mins to mix well while avoiding entrapping air. The full coating composition was then applied to precleaned stainless steel Q panels, with an applicator bar. Before drying in a controlled temperature oven at 30° C. A minimum cure time of 7 days was allowed before testing and analysis of the panels.

Preparation Method B2: Stage I: To an appropriate jar/container (or reaction vessel, typically a 150 mL glass jar) was added 50% aqueous sodium hydroxide solution, additional sodium hydroxide solid (as required, not in all examples) and lithium hydroxide solid (as required, not in all examples). A blanket of nitrogen was applied to avoid carbonation of the alkali solution. This was gently stirred until maximum dissolution had occurred. This was then diluted with the additional water added dropwise with stirring (EXOTHERMIC—temperature of the mixture was cooled such that the process temperature did not exceed 60° C.). After this addition and 10-15 mins for complete mixing, colloidal silica, LUDOX™—50 was added dropwise. On completion of the addition, the mixture was stirred until the solution was homogeneous and all solid had dissolved. Stage IIa: Separately, a polymer/surfactant premix was created by the addition of the surfactant, DOWFAX™ 2Al to the emulsion polymer, Carboset® 7160RC mixing slowly until homogeneous. Stage In: A portion of the prepared alkali silicate solution was placed in a suitable container ready for mixing in the polymer/surfactant premix. The mixture was cooled to 15-20° C. A high sheer mixing regime was then used where the polymer premix portion was added directly into the high sheer mixing area of the container. High stirrer speeds of greater than 900 rpm were used. The polymer premix was added dropwise (slowly) into the alkali silicate solution with high sheer mixing over 10-15 mins. Mixing was then continued for a further 30 minutes to further break up agglomerates. After completion a small sample (5 g) was removed and placed into a small 28 mL glass vial for stability studies, the remainder was then used in Stage IV. The product of this stage of the preparation was the activating liquid of Preparation Method B and could be stored before using in the full coating composition. Stage III: Separately, metakaolin was combined with 8% yttria stabilized zirconium oxide in a suitable glass jar, this jar was then sealed, and the dry powders mixed on a lab roller mixer until homogeneous. The product of this preparation provides the reactive solid of Preparation Method B and could be stored before using in the full coating composition. Stage IV: To the desired quantity of activating liquid was then added the reactive solid, using hand mixing with a spatula to wet the solid and then using gentle/slow stirring for 5-10 mins to mix well while avoiding entrapping air. The full coating composition was then applied to precleaned stainless steel Q panels, with an applicator bar. Before drying in a controlled temperature oven at 30° C. A minimum cure time of 7 days was allowed before testing and analysis of the panels.

TABLE 1
Raw materials used to prepare the activating liquid part of the formulation in grams.

| | | Sodium | | | | | | | | |
|---|---|---|---|---|---|---|---|---|---|---|
| | | Hydroxide | Sodium | Lithium | Colloidal | | | | | |
| | | (50% | Hydroxide | hydroxide | Silica | Sodium | | | Emulsion | |
| | | aq) | (solid) | (solid) | (Ludox ™-50) | metasilicate | Water | Emulsion | Polymer | |
| Ex. | Method | (g) | (g) | (g) | (g) | (g) | (g) | Polymer | (g) | Surfactant³ |
| 1 | A | 0.0 | | | 0.0 | 39.6 | 56.8 | A¹ | 30.0 | |
| 2 | A | 0.0 | | | 0.0 | 39.6 | 75.6 | A | 30.0 | |
| 3 | A | 0.0 | | | 0.0 | 39.6 | 56.8 | A | 30.0 | |
| 4 | A | 0.0 | | | 0.0 | 39.6 | 75.6 | A | 30.0 | |
| 5 | B | 69.2 | | | 69.3 | 0.0 | 11.4 | B² | 41.4 | |
| 6 | B | 69.2 | | | 69.3 | 0.0 | 11.4 | B | 41.4 | |
| 7 | B | 78.2 | | | 62.4 | 0.0 | 9.4 | B | 41.4 | |
| 8 | B | 43.9 | | | 89.0 | 0.0 | 17.1 | B | 41.4 | |
| 9 | B | 78.2 | | | 62.4 | 0.0 | 9.4 | B | 41.4 | |
| 10 | B | 43.9 | | | 89.0 | 0.0 | 17.1 | B | 41.4 | |
| 11 | B2 | 32.6 | 4.6 | | 32.9 | 0.0 | 0.0 | B | 30.1 | 1.2 |
| 12 | B2 | 32.6 | 4.6 | | 32.9 | 0.0 | 0.0 | B | 15.2 | 0.6 |
| 13 | B2 | 31.1 | | | 29.2 | 0.0 | 6.3 | B | 18.0 | 0.7 |
| 14 | B2 | 34.6 | | 5.5 | 24.7 | 0.0 | 5.9 | B | 18.1 | 0.7 |
| 15 | B2 | 28.1 | | 4.5 | 30.1 | 0.0 | 7.3 | B | 18.1 | 0.7 |
| 16 | B2 | 26.6 | | 4.3 | 38.0 | 0.0 | 1.0 | B | 20.3 | 0.8 |
| 17 | B2 | 18.7 | | 12.6 | 28.0 | 0.0 | 16.6 | B | 16.0 | 0.6 |
| 18 | A | 0.0 | | | 0.0 | 39.6 | 56.8 | A | 30.0 | |
| 19 | A | 0.0 | | | 0.0 | 38.3 | 58.1 | B | 25.8 | |
| 20 | A | 0.0 | | | 0.0 | 0.0 | 0.0 | A | 100% | |
| 21 | A | 0.0 | | | 0.0 | 65 | 120.8 | | 0.0 | |

¹Emulsion Polymer A is Hycar ® 26951 from Lubrizol Advanced Materials, Inc., which has a polymer solids content of 49.5% by weight and a Tg of-11° C.
²Emulsion Polymer B is Carboset ® 7160RC from Lubrizol Advanced Materials, Inc. which has a polymer solids content of 44% by weight and a Tg of 18° C.
³DOV/FAX ™ 2A1 solution surfactant from Dow, Inc.

TABLE 2
Raw materials used to prepare the reactive
solids part of the formulation

| | | Zirconium Oxide |
|---|---|---|
| Ex. | Metakaolin (g) | (8% Yttria stabilised) (g) |
| 1 | 39.6 | 0.0 |
| 2 | 39.6 | 0.0 |
| 3 | 39.6 | 5.8 |
| 4 | 39.6 | 5.8 |
| 5 | 65.0 | 0.0 |
| 6 | 65.0 | 4.4 |
| 7 | 70.0 | 0.0 |
| 8 | 70.0 | 0.0 |
| 9 | 50.0 | 0.0 |
| 10 | 50.0 | 0.0 |
| 11 | 29.0 | 1.9 |
| 12 | 28.8 | 1.6 |
| 13 | 25.6 | 1.6 |
| 14 | 25.8 | 1.6 |
| 15 | 25.8 | 1.6 |
| 16 | 29.1 | 1.7 |
| 17 | 22.8 | 1.5 |
| 18 | 39.6 | 0.0 |
| 19 | 38.3 | 0.0 |
| 20 | 0.0 | 0.0 |
| 21 | 65.0 | 0.0 |

TABLE 3
Overall Weight Percentage for the full coating composition

| | | | polyacrylate | | Zirconium | |
|---|---|---|---|---|---|---|
| | | | emulsion | | Oxide | Additional |
| | | alkali | polymer | | (8% Yttria | Surfactant |
| Ex. | water | silicate | solids | Metakaolin | stabilised) | Actives |
| 1 | 44.3 | 23.9 | 8.0 | 23.9 | 0.0 | |
| 2 | 50.0 | 21.4 | 7.1 | 21.4 | 0.0 | |
| 3 | 42.8 | 23.1 | 7.7 | 23.1 | 3.4 | |
| 4 | 48.5 | 20.8 | 6.9 | 20.8 | 3.0 | |
| 5 | 42.7 | 24.0 | 8.0 | 25.4 | 0.0 | |
| 6 | 42.0 | 23.6 | 7.9 | 24.9 | 1.7 | |
| 7 | 41.9 | 23.5 | 7.8 | 26.8 | 0.0 | |
| 8 | 41.9 | 23.5 | 7.8 | 26.8 | 0.0 | |
| 9 | 45.3 | 25.5 | 8.5 | 20.7 | 0.0 | |
| 10 | 45.3 | 25.5 | 8.5 | 20.7 | 0.0 | |
| 11 | 45.0 | 20.0 | 11.3 | 21.9 | 1.4 | 0.4 |
| 12 | 44.5 | 22.6 | 6.5 | 24.8 | 1.4 | 0.2 |
| 13 | 46.9 | 20.8 | 7.9 | 22.8 | 1.4 | 0.3 |
| 14 | 44.8 | 23.8 | 7.7 | 22.1 | 1.4 | 0.3 |
| 15 | 59.4 | 24.0 | 9.4 | 5.2 | 1.7 | 0.3 |
| 16 | 47.3 | 18.9 | 8.31 | 23.9 | 1.4 | 0.3 |
| 17 | 55.9 | 16.3 | 6.8 | 19.5 | 1.3 | 0.2 |
| 18 | 44.3 | 23.9 | 8.0 | 23.9 | 0.0 | |
| 19 | 44.3 | 23.9 | 8.0 | 23.9 | 0.0 | |
| 20 | 56.0 | 0.0 | 44.0 | 0.0 | 0.0 | |
| 21 | 48.2 | 25.9 | 0.0 | 25.9 | 0.0 | |

TABLE 4
Hardness Measures for Examples 1-4.

| | Hardness measurement | | Hardness measurement | |
|---|---|---|---|---|
| | (after 2 hrs at | | (after 2 hrs at 75° C. | |
| | 30° C. prior to testing) | | prior to testing) | |
| | Pencil | Knoop | Pencil | Knoop |
| | Hardness | Hardness | Hardness | Hardness |
| Ex. | (ASTM D3363) | (ASTM E384) | (ASTM D3363) | (ASTM E384) |
| 1 | 5 H | 250 | 5 H | 250 |
| 2 | 5 H | 177 | 5 H | 177 |
| 3 | 9 H | 585 | 9 H | 418 |
| 4 | 9 H | 508 | 9 H | 850 |

200 μm Film thickness (wet)

Progressive scratch and change in Max Si—O—Si Stretch

| | Progressive load scratch test | Change in max Si—O—Si stretch position in FTIR |
|---|---|---|
| | (UMT tribolab)—critical load | (cm⁻¹) between 1 day and 2 months |
| Example | (N) (ASTM C1624-05(2015)¹ | (ASTM E573)² |
| 5 | 6 | −11.14 |
| 6 | 20 | 54.69 |
| 11 | 15.5 | Not tested |
| 12 | 18.5 | Not tested |
| 13 | 30.6 | Not tested |
| 14 | 21.0 | Not tested |
| 15 | 19.6 | Not tested |
| 16 | 19.7 | Not tested |
| 17 | 9.4 | Not tested |
| 18 | 13 | Not tested |
| 20 | 1 | Not tested |
| 21 | 6 | Not tested |

¹Standarc Test Method for Adhesion Strength and Mechanical Failure Modes of Ceramic Coatings by Quantitative Single Point Scratch Testing, run on a UMT-Tribolab from Bruker.
²ATR FTIR measurements of the coatings surface were taken after 1 day after drawdown of the coating mixture and drying, and then after 2 months. The peak absorbance due to Si—O—Si stretch were picked at both time points and the change in the position of this determined to give this measure.

Except in the Examples, or where otherwise explicitly indicated, all numerical quantities in this description specifying amounts of materials, reaction conditions, molecular weights, number of carbon atoms, and the like, are to be understood as modified by the word “about.” It is to be understood that the upper and lower amount, range, and ratio limits set forth herein may be independently combined. Similarly, the ranges and amounts for each element of the invention can be used together with ranges or amounts for any of the other elements.

As used herein, the transitional term “comprising,” which is synonymous with “including,” “containing,” or “characterized by” is inclusive or open-ended and does not exclude additional, un-recited elements or method steps. However, in each recitation of “comprising” herein, it is intended that the term also encompass, as alternative embodiments, the phrases “consisting essentially of” and “consisting of,” where “consisting of” excludes any element or step not specified and “consisting essentially of” permits the inclusion of additional un-recited elements or steps that do not materially affect the basic and novel characteristics of the composition or method under consideration.

While certain representative embodiments and details have been shown for the purpose of illustrating the subject invention, it will be apparent to those skilled in this art that various changes and modifications can be made therein without departing from the scope of the subject invention. In this regard, the scope of the invention is to be limited only by the following claims.

1. A reactive coating system comprising:
(A) an activating liquid comprising
(1) a polymer emulsion comprising polyacrylate latex polymer solids or the powdered polymer derived therefrom;
(2) an alkali silicate;
(3) solvent; and
(B) a reactive solid mixture comprising (1) an aluminosilicate.

2. The reactive coating system of claim 1, wherein the reactive solid mixture further comprises (2) an amphoteric metal oxide.

3. The reactive coating system of claim 2, wherein the amphoteric metal oxide is a metal oxide containing a group 3 or 4 transition metal species or a group 13 element or mixtures thereof.

4. The reactive coating system of claim 3, wherein the amphoteric metal oxide is selected from boron oxide, aluminum oxide, zirconium oxide, scandium oxide, yttrium oxide, zinc oxide, hafnium oxide or mixtures thereof.

5. The reactive coating system of claim 2, wherein the amphoteric metal oxide comprises or consists of zirconium oxide.

6. The reactive coating system of claim 2, wherein the amphoteric metal oxide comprises or consists of yttria stabilized zirconium oxide.

7. The reactive coating system of claim 1, wherein the alkali silicate is represented by the formula M₂ₙSiO₂₊ₙ.

8. The reactive coating system of claim 7, wherein M represents sodium, lithium, or potassium, or mixtures thereof.

9. The reactive coating system of claim 7, wherein n is 0.33 to 1.33 or 0.63 to 1.25.

10. The reactive coating system of claim 1, wherein the alkali silicate comprises or consists of sodium metasilicate.

11. The reactive coating system of claim 1, wherein the alkali silicate comprises the reaction product of (a) an alkali metal oxide, an alkali metal hydroxide, an alkali metal carbonate, an alkali metal bicarbonate, or mixtures thereof with (b) colloidal silica.

12. The reactive coating system of claim 1, wherein the polyacrylate latex polymer solids or the powdered polymer derived therefrom have a glass transition temperature of less than 150° C., or less than 100° C., or less than 75° C., or less than 40° C., or less than 30° C.

13. The reactive coating system of claim 1, wherein the polyacrylate latex polymer solids or the powdered polymer derived therefrom have a glass transition temperature of at least −40° C., or at least −20° C., or at least −10° C., or at least −5° C.

14. The reactive coating system of claim 1, wherein the solvent comprises water.

15. The reactive coating system of claim 14, wherein the solvent further comprises one or more co-solvents miscible with water selected from C1-6 aliphatic alcohols, C2-6 alkylene glycols, alcohol ethers, glycol ethers, glycol esters, and polyglycols having a MW less than 600

16. The reactive coating system of claim 1, further comprising one or more additives selected from humectants, surfactants, rheology modifiers/thickeners, antifoams, defoamers, preservatives, biocides, levelling agents, organic pigments, inorganic pigments, fillers, flame retardants, and mixtures thereof.

17. The reactive coating system of claim 1, wherein the aluminosilicate comprises is derived from calcined clay, incineration ash, natural pozzolans, volcanic ash, ground granulated blast furnace slag, industrial ground slag, mine tailings or wastes, zeolite, feldspars, framework aluminosilicates, synthetic glassy precursors (silicates, aluminates, aluminosilicates) and mixtures thereof.

18. The reactive coating system of claim 1, wherein the aluminosilicate comprises or consists of metakaolin.

19. The reactive coating system of claim 2, wherein:
(A) 20% to 90%, or 60% to 85%, or 70% to 80% by weight of the activating liquid, wherein the activating liquid comprises
(1) 0.5% to 35%, or 2% to 30%, or 5% to 25% by weight the latex polymer solids of a polyacrylate emulsion polymer or the powdered polymer derived therefrom;
(2) 5% to 49%, or 18% to 45%, or 30% to 40% by weight alkali silicate;
(3) 16% to 94.5%, or 25% to 80%, or 35% to 65% by weight solvent; and
(4) 0% to 15%, or 0% to 10% by weight or one or more additives;
(B) 10% to 80%, or 5% to 40% or 20% to 30% by weight of the reactive solid mixture, wherein the reactive sold mixture comprises
(1) 70% to 99.5%, or 80% to 99%, or 85% to 99% by weight aluminosilicate; and
(2) 0.5% to 30%, or 1% to 20%, or 1% to 15% amphoteric metal oxide.

20. A reactive coating composition comprising:
(A) an activating liquid comprising
(1) a polyacrylate emulsion polymer or the powdered polymer derived therefrom; and
(2) an aqueous alkali silicate solution, wherein the aqueous alkali silicate solution comprises (a) a reactive alkali metal component, selected from an alkali metal oxide, an alkali metal hydroxide, an alkali metal carbonate, an alkali metal bicarbonate, or mixtures thereof, (b) colloidal silica, and (c) water;
and
(B) a reactive solid mixture comprising
(1) an aluminosilicate.

21. The reactive coating composition of claim 19 wherein the reactive solid mixture further comprises (2) an amphoteric metal oxide.

22. The reactive coating composition of claim 21, wherein the amphoteric metal oxide is selected from boron oxide, aluminum oxide, zirconium oxide, scandium oxide, yttrium oxide, zinc oxide, hafnium oxide or mixtures thereof.

23. The reactive coating composition of claim 21, wherein the amphoteric metal oxide comprises or consists of zirconium oxide.

24. The reactive coating composition of claim 21, wherein the amphoteric metal oxide comprises or consists of yttria stabilized zirconium oxide.

25. The reactive coating composition of claim 20, wherein the alkali silicate is represented by the formula M₂ₙSiO₂₊ₙ.

26. The reactive coating composition of claim 25, wherein M represents sodium, lithium, or potassium, or mixtures thereof.

27. The reactive coating composition of claim 25, wherein n is 0.33 to 1.33 or 0.63 to 1.25.

28. The reactive coating composition of claim 19, wherein the aqueous alkali silicate solution comprises or consists of (a) sodium hydroxide, (b) colloidal silica, and (c) water.

29. The reactive coating composition of claim 19, wherein the colloidal silica comprises 5% to 60% or 45% to 60% by weight SiO₂ particles.

30. The reactive coating composition of claim 20, wherein the polyacrylate emulsion polymer has a glass transition temperature of less than 150° C., or less than 100° C., or less than 75° C., or less than 40° C., or less than 30° C.

31. The reactive coating composition of claim 20, wherein the polyacrylate emulsion polymer has a glass transition temperature of at least −40° C., or at least −20° C., or at least −10° C., or at least −5° C.

32. The reactive coating composition of claim 20, wherein the activating liquid further comprises one or more additives selected from humectants, surfactants, rheology modifiers/thickeners, antifoams, defoamers, preservatives, biocides, levelling agents, organic pigments, inorganic pigments, fillers, flame retardants, and mixtures thereof.

33. The reactive coating composition of claim 20, wherein the aluminosilicate is wherein the aluminosilicate is preferably metakaolin or another calcined clay but can also be selected from the following solid precursors, fly ash, incineration ash (including but not limited to rice husk, sugarcane leaves ash, palm oil, boiler ash, wastepaper sludge ash, municipal solid waste ash, bottom ash), natural pozzolans, volcanic ash, ground granulated blast furnace slag (from steel or iron), other industrial ground slag (including but not limited to phosphorous, ferronickel, ferrochrome magnesia-iron, copper, nickel, titaniferous), mine tailings or wastes (including but not limited to coal gangue, red mud), zeolite, feldspars, framework aluminosilicates, synthetic glassy precursors (silicates, aluminates, aluminosilicates) and mixtures thereof.

34. The reactive coating composition of claim 20, wherein the aluminosilicate comprises or consists of metakaolin.

35. The reactive coating composition of claim 20, wherein the coating composition comprises:
(A) 20% to 90%, or 60% to 85%, or 70% to 80% by weight of the activating liquid, wherein the activating liquid comprises
(1) 0.5% to 35%, or 2% to 30%, or 5% to 25% by weight the latex polymer solids of a polyacrylate emulsion polymer or the powdered polymer derived therefrom;
(2) 5% to 49%, or 18% to 47%, or 30% to 45% by weight alkali silicate;
(3) 16% to 94.5%, or 23% to 80%, or 30% to 55% by weight solvent; and
(4) 0% to 15%, or 0.5% to 10% by weight or one or more additives;
(B) 10% to 80%, or 15% to 40%, or 20% to 30% by weight of the reactive solid mixture, wherein the reactive sold mixture comprises
(1) 90% to 99.5%, or 93% to 99%, or 95% to 99% by weight aluminosilicate; and
(2) 0.5% to 10%, or 1% to 7%, or 1% to 5% amphoteric metal oxide.

36. A coating composition comprising:
(a) a geopolymer component, wherein the geopolymer component comprises the reaction product of an alkali metal silicate and an aluminosilicate;
(b) a polyacrylate polymer emulsion; and
(c) an amphoteric metal oxide.

37. The coating composition of claim 36, wherein the alkali silicate is represented by the formula M₂ₙSiO₂₊ₙ.

38. The coating composition of claim 37, wherein M represents sodium, lithium, or potassium, or mixtures thereof.

39. The coating composition of claim 36, wherein n is 0.33 to 1.33 or 0.63 to 1.25.

40. The coating composition of claim 36, wherein the geopolymer component has an Si/Al molar ratio of 1 to 4 or 1.5 to 3.

41. The coating composition of claim 36, wherein the alkali silicate comprises the reaction product of (a) an alkali metal oxide, an alkali metal hydroxide, an alkali metal carbonate, an alkali metal bicarbonates, or mixtures thereof with (b) colloidal silica.

42. The coating composition of claim 36, wherein the polyacrylate polymer emulsion further comprises additives selected from surfactants, defoamers, latex stabilizers and combinations thereof.

43. The coating composition of claim 36, wherein the aluminosilicate is selected fly ash, incineration ash (including but not limited to rice husk, sugarcane leaves ash, palm oil, boiler ash, wastepaper sludge ash, municipal solid waste ash, bottom ash), natural pozzolans, volcanic ash, ground granulated blast furnace slag (from steel or iron), other industrial ground slag (including but not limited to phosphorous, ferronickel, ferrochrome magnesia-iron, copper, nickel, titaniferous), mine tailings or wastes (including but not limited to coal gangue, red mud), zeolite, feldspars, framework aluminosilicates, synthetic glassy precursors (silicates, aluminates, aluminosilicates) and mixtures thereof.

44. The coating composition of claim 36, wherein the aluminosilicate comprises or consists of metakaolin.

45. The coating composition of claim 36, wherein the amphoteric metal oxide is selected from boron oxide, aluminum oxide, zirconium oxide, scandium oxide, yttrium oxide, zinc oxide, hafnium oxide or mixtures thereof.

46. The coating composition of claim 45, wherein the amphoteric metal oxide comprises or consists of zirconium oxide.

47. The coating composition of claim 36, wherein the alkali metal silicate is a sodium silicate.

48. The coating composition of claim 36, wherein the coating composition has an Si/Al ratio of 0.5 to 3.0 or 1.5 to 2.5.

49. The coating composition of claim 36, wherein the coating composition has an M/Al ratio of 0.5 to 2.5 or 1.0 to 2.0.
